(19) United States
(12) Patent Application Publication
(10) Pub. No.: US 2017/0283629 A1
(43) Pub. Date: Oct. 5, 2017

(54) METAL-BASED INK FOR ADDITIVE MANUFACTURING PROCESS

(71) Applicant: University of North Texas, Denton, TX (US)

(72) Inventor: Aleksandra Fortier, Coppell, TX (US)

(21) Appl. No.: 15/472,325

(22) Filed: Mar. 29, 2017

Related U.S. Application Data
(60) Provisional application No. 62/314,602, filed on Mar. 29, 2016.

(51) Int. Cl. C09D 11/03; B33Y 70/00

(52) U.S. Cl. CPC C09D 11/03; B33Y 70/00

(57) ABSTRACT

The present invention includes an ink and method of applying the ink on a surface, wherein the ink comprises metal particles, an organic stabilizer, and a solvent, and methods of making electronic systems coated with the ink.

### CROSS-REFERENCE TO RELATED APPLICATIONS

This application claims priority based on U.S. Provisional Application No. 62/314,602, filed Mar. 29, 2016. The contents of which is incorporated by reference in its entirety.

### TECHNICAL FIELD OF THE INVENTION

The present invention relates in general to the field of manufacturing processes and materials for electronic systems, and more particularly, to novel metal-based inks and methods of using the metal-based inks for making electronic devices.

### STATEMENT OF FEDERALLY FUNDED RESEARCH

None.

### BACKGROUND OF THE INVENTION

Without limiting the scope of the invention, its background is described in connection with making inks for use in electronic devices.

U.S. Patent Publication No. 20140035995, filed by Chou, et al., is entitled “Aerosol jet printable metal conductive inks, glass coated metal conductive inks and UV-curable dielectric inks and methods of preparing and printing the same”. Briefly, this application is said to teach aerosol jet uncoated and coated (e.g., glass-coated) metal conductive ink compositions that can be deposited onto a substrate using, for example, aerosol jet printing and direct-write methods such as Aerosol Jet (e.g., Optomec® M 3D) deposition and methods of aerosol jet deposition of the aerosol jet uncoated and coated metal conductive ink compositions. The application is also said to teach aerosol jet UV curable dielectric ink compositions that exhibit transparency, storage stability, and very good print quality and print stability, thereby enabling the formation of very fine dielectric features on a variety of substrates.

International Publication No. WO 2009029939 A2, filed by King and Ramahi, is entitled “Aerosol jet® printing system for photovoltaic applications” as is said to teach a method and apparatus for depositing multiple lines on an object, specifically contact and busbar metallization lines on a solar cell. Further, the application is said to teach the use of multiple materials that can be deposited, on top of one another, forming layered structures on the object. Each layer can be less than five microns thick.

Yet another ink is disclosed by Shukenshi, et al., “Investigation Of Aerosol Jet Deposition Parameters For Printing SOFC Layers”, Proceedings of the ASME 2010 Eighth International Fuel Cell Science, Engineering and Technology Conference Fuel Cell 2010 Jun. 14-16, 2010, Brooklyn, N.Y., USA, which teaches the printing of dense and porous layers necessary for solid oxide fuel cells that include a yttria stabilized zirconia (YSZ) electrolyte, a strontium doped lanthanum manganite (LSM) NSZ cathode functional interlayer, and a neat LSM cathode current collection layer.

### SUMMARY OF THE INVENTION

In one embodiment, the present invention includes an ink comprising, metal particles, an organic stabilizer, and a solvent. In one aspect, the metal is selected from tin (Sn), zinc (Zn), magnesium (Mg), lithium (Li), bismuth (Bi), antimony (Sb), alloys, or high entropy alloys (HEAs). In another aspect, the organic stabilizer is provided at between 0.01% to 2.0% weight to volume. In another aspect, the organic stabilizer is provided at between 0.05% to 0.5% weight to volume. In another aspect, the organic stabilizer is selected from the group consisting of agar, agarose, alginate, carrageenan, gelatin, guar gum, gum arabic, gum ghatti, gum tragacanth, karaya gum, locust bean gum, xanthan gum, cellulose, pectin, mucin, dextran, starch, heparin, chitosan, hydroxy starch, hydroxypropyl starch, carboxymethyl starch, hydroxyethyl cellulose, hydroxypropyl cellulose, carboxymethyl cellulose, acrylic polymer, polyamide, polyimide, polyester, polyether, polymeric vinyl compounds, polyalkene, substituted derivatives thereof, copolymers, substituted derivatives, and mixtures thereof. In another aspect, the solvent is water. In another aspect, the organic stabilizer is a thixotropic agent. In another aspect, the metal is defined further as metal particles having a size range from 5 to 250 nm, from 10 to 250 nm, from 50 to 150 nm, or an average size of 100, 125, 150, or 175 nm. In another aspect, the further comprises at least one of a preservative, a flux, or a color.

Yet another embodiment of the present invention includes a method of using a metal ink comprising: mixing a stabilized ink comprising metal particles, an organic stabilizer, and a solvent, wherein the ink is loaded into an ink cartridge; preparing a surface in need of coating with a metal; and spraying the stabilized ink from the cartridge using a printer, onto the substrate to increase at least one or appearance, solderability, or electric conductivity of the surface of the substrate. In one aspect, metal is selected from tin (Sn), zinc (Zn), magnesium (Mg), lithium (Li), bismuth (Bi), antimony (Sb), alloys, or high entropy alloys (HEAs). In another aspect, the organic stabilizer is provided at between 0.01% to 2.0% weight to volume. In another aspect, the organic stabilizer is provided at between 0.05% to 0.5% weight to volume. In another aspect, the organic stabilizer is selected from the group consisting of agar, agarose, alginate, carrageenan, gelatin, guar gum, gum arabic, gum ghatti, gum tragacanth, karaya gum, locust bean gum, xanthan gum, cellulose, pectin, mucin, dextran, starch, heparin, chitosan, hydroxy starch, hydroxypropyl starch, carboxymethyl starch, hydroxyethyl cellulose, hydroxypropyl cellulose, carboxymethyl cellulose, acrylic polymer, polyamide, polyimide, polyester, polyether, polymeric vinyl compounds, polyalkene, substituted derivatives thereof, copolymers, substituted derivatives, and mixtures thereof. In another aspect, the solvent is water. In another aspect, the organic stabilizer is a thixotropic agent. In another aspect, the method further comprises at least one of a preservative, a flux, or a color. In another aspect, the metal is defined further as metal particles having a size range from 5 to 250 nm, from 10 to 250 nm, from 50 to 150 nm, or an average size of 100, 125, 150, or 175 nm.

Yet another embodiment of the present invention includes a method of making an electronic device comprising: obtaining a stabilized ink comprising metal particles, an organic stabilizer, and a solvent, wherein the ink is loaded into an ink cartridge; preparing a surface comprising one or more electronic components in need of coating with a metal; and printing the stabilized ink from the cartridge using a printer onto the electronic component to increase at least one or appearance, solderability, or electric conductivity of the electronic component. In one aspect, the metal is selected from tin (Sn), zinc (Zn), magnesium (Mg), lithium (Li), bismuth (Bi), antimony (Sb), alloys, or high entropy alloys (HEAs). In another aspect, the organic stabilizer is provided at between 0.01% to 2.0% weight to volume. In another aspect, the organic stabilizer is provided at between 0.05% to 0.5% weight to volume. In another aspect, the organic stabilizer is selected from the group consisting of agar, agarose, alginate, carrageenan, gelatin, guar gum, gum arabic, gum ghatti, gum tragacanth, karaya gum, locust bean gum, xanthan gum, cellulose, pectin, mucin, dextran, starch, heparin, chitosan, hydroxy starch, hydroxypropyl starch, carboxymethyl starch, hydroxyethyl cellulose, hydroxypropyl cellulose, carboxymethyl cellulose, acrylic polymer, polyamide, polyimide, polyester, polyether, polymeric vinyl compounds, polyalkene, substituted derivatives thereof, copolymers, substituted derivatives, and mixtures thereof. In another aspect, the solvent is water. In another aspect, the organic stabilizer is a thixotropic agent. In another aspect, the method further comprises at least one of a preservative, a flux, or a color. In another aspect, the metal is defined further as metal particles having a size range from 5 to 250 nm, from 10 to 250 nm, from 50 to 150 nm, or an average size of 100, 125, 150, or 175 nm.

### BRIEF DESCRIPTION OF THE DRAWINGS

For a more complete understanding of the features and advantages of the present invention, reference is now made to the detailed description of the invention along with the accompanying figures and in which:

FIG. 1A shows a Sn nano-powder used with the present invention, and FIG. 1B shows the Sn ink ready for processing.

FIG. 2A Scanning Electron Microscope Image (SEM) scan shows the actual deposition confirming the functionality of the custom developed Sn ink. FIG. 2B shows an Energy Dispersive Spectroscopy (EDS) image confirming the Sn material content present in the “white line” region shown in image FIG. 2A.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

Electronic systems components undergo electroplating processes for corrosion resistance, better outside appearance, solderability, and increased electrical conductivity. Metals, such as tin (Sn), zinc (Zn), magnesium (Mg), lithium (Li), bismuth (Bi), antimony (Sb), or even alloys, such as high entropy alloys (HEAs), can be used as part of a primary coating material used in these processes. The metal used in the ink will generally be metal particles having a size range from 5 to 250 nm, from 10 to 250 nm, from 50 to 150 nm, or an average size of 100, 125, 150, or 175 nm. As electronics decrease in size the number of reliability issues increases which demands application and adaptability of clean, sustainable, and environmentally friendly manufacturing processes. Additive manufacturing processes are good candidates that can coat components using variety of materials at lower cost and with decreased reliability issues. The specific technology used for this work is the aerosol jet technology to print and coat components on any material surface. However, the available metal materials in a form of ink for the aerosol jet technology is limited which limits the application for metal-coated electronic components. This invention is centered on development of metal inks, from a metal powder, that can be used in additive manufacturing process to build or coat small-scale electronic components found in electronic circuit boards and lead frames.

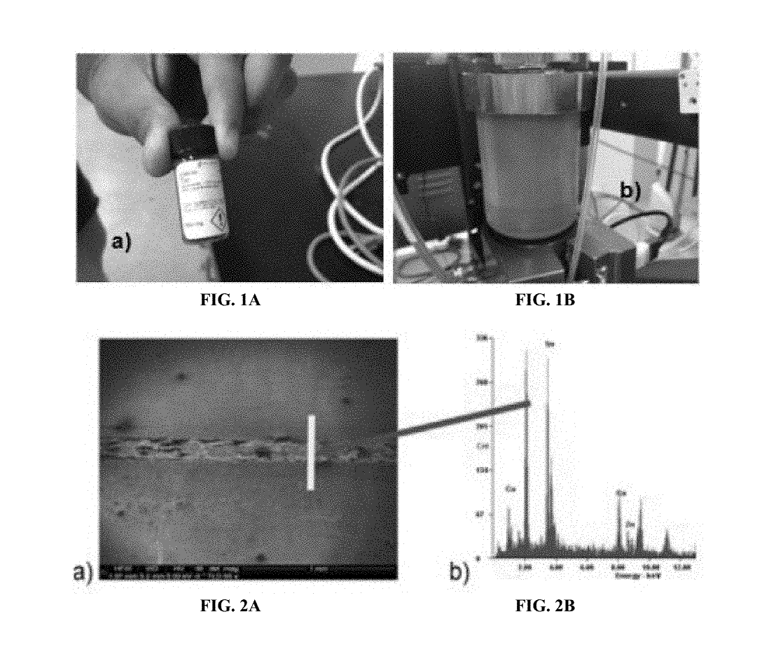

The ink of the present invention can be formed, deposited, printed or applied onto a surface to form, e.g., a film material that has the desired electronic properties. For example, pure Sn (or other metals) particles can be suspected in an ink-based material that is used in an additive manufacturing process. In one non-limiting example, the present inventors developed a Sn-based ink that is compatible with aerosol jet machine or printers to deposit Sn-based solution ink with the aerosol 3D jet. The metal-ink composition, included: 100 ml distill water, a 0.1% weight agar additive, which serves as organic stabilizer and eliminates particle agglomeration, and 2.5 g of Sn-based nano-powder with a Sn metal particle size of 150 nm (FIG. 1A). Sn metal powder included particle sizes of an average 150 nm is because the particle size specification for the other ink solutions available on the market (Ag, Cu, Au, Ni, etc.) and compatible with the Aerosol 3D Jet tool is between 5 and 200 nm. Sn nano-powder with 150 nm particle size was available for purchase and compatible with the process specifications. The amount and the type of organic additives was examined via trial and error experiments and 0.1% weight agar was selected as the most suitable amount and type of additive that made the ink functional.

An organic stabilizer for use with the present invention can be selected from, e.g., agar, agarose, alginate, carrageenan, gelatin, guar gum, gum arabic, gum ghatti, gum tragacanth, karaya gum, locust bean gum, xanthan gum, cellulose, pectin, mucin, dextran, starch, heparin, chitosan, hydroxy starch, hydroxypropyl starch, carboxymethyl starch, hydroxyethyl cellulose, hydroxypropyl cellulose, carboxymethyl cellulose, acrylic polymer, polyamide, polyimide, polyester, polyether, polymeric vinyl compounds, polyalkene, substituted derivatives thereof, copolymers, substituted derivatives, and mixtures thereof at between 0.01% to 2.0% weight to volume. The organic stabilizer can be provided at between 0.05% to 0.5% weight to volume.

It has been found that current Sn-ink formulation can be applied for development of other metal based inks in pure form or alloys which are also not available on the market among which zinc (Zn), bismuth (Bi), antimony (Sb) and many other metal, polymer and biomaterials that will benefit wide range of application.

Further, in addition to coating electronic components with improved reliability at low cost, the present invention find a particular use in printing green solders for circuit boards in electronics which also suffer from reliability issues. Further, development of other inks following the receipt of this invention can allow printing of many components that also have reliability issues or need better properties so they can be adapted in various assemblies.

The components of the ink of the present invention can be varied as follows. The metal ink composition, custom made for the first time, contained: 100 ml distill water, a 0.1% weight agar additive which serves as organic stabilizer and eliminates particle agglomeration, and 2.5 g of metal-based nano-powder with a metal particle size of 150 nm (in FIG. 1A the metal is Sn). To scale up the amount of ink, the amount of each component to the mixture and optimize functionality. Novel inks can be made using the method described above in which matching the organic additive and its amount to produce functional ink specifically suitable for additive manufacturing can be achieved.

The present invention provides distinct advantages over the prior art. The current technology for coating electronic components is electroplating, which produces low quality coatings with reliability issues such as growth of metal dendrites, high stress, delamination from the substrate, and high in oxidation. Electroplating also requires post-processing steps for the coating such as sintering in conventional air-filled oven, and hazardous chemicals. The novel ink and methods for, e.g., 2D or 3D printing using a Sn-based coating, produces high quality films, low stress, superior adhesion to the substrate and no oxidation. A further benefit of the ink of the present invention when used in 2D or 3D printing is that it does not require post-processing steps or hazardous chemicals therefore, invention of this Sn ink to be able to print electronic coatings and circuit boards will produce great benefit and risk-free products to consumers of electronic devices.

The following are metals that can be used to manufacture the printing ink that can be deposited with aerosol jet printing technology.

The following properties of Tin (Sn) find particular use with the present invention as Sn is a post-transitional metal, is corrosion-resistant, malleable, ductile and highly crystalline silvery-white metal, low melting point-melts at around 200° C. The properties provide several reasons why aerosol jet technology is suitable for depositing Sn because it operates at low temperatures and prevents Sn to change properties during deposition as opposed to a traditional electroplating process where Sn changes properties even at ambient temperature. Tin can be alloyed with elements such as copper, antimony, bismuth, cadmium and silver to increase Sn hardness. However, depending on the nature of application sometimes alloying of these elements with Sn can require process modification for aerosol jet deposition. In one example, more that one individually aerosolized ink is mixed together on the fly as they enter the deposition head, which allows control of volume of mixing between the alloying elements and opportunity to design unique properties of the deposited film using pattering function for specific applications.

The following properties of Sn find particular use with the present invention. Sn can be used in many applications, e.g., Sn plating of steel, lead, and zinc parts for corrosion protection and better outside appearance. Sn-plated steel containers are widely used for food preservation, and this forms a large part of the market for metallic tin. Sn is widely used in lead (Pb)-free solder pastes found in interconnects in electronics. However, ever since European Union imposed a law effective 1 Jul. 2006 on Waste Electrical and Electronic Equipment Directive (WEEE Directive) and Restriction of Hazardous Substances Directive Sn-based solders without lead have been used that show many reliability issues such as higher melting point, formation of Sn whiskers causing short circuits, Sn-pest issue that causes loss of the soldered joint etc. Tin is also used as a negative electrode in advanced Li-ion batteries but its application is somewhat limited by the fact that some tin surfaces catalyze decomposition of carbonate-based electrolytes used in Li-ion batteries. Also, large volumetric expansion of tin upon alloying with lithium and instability of the tin-organic electrolyte interface at low electrochemical potentials are the greatest challenges in employing it in commercial cells. Many of these issues could potentially be mitigated in Sn when used in ink form and deposited by aerosol jet technology by producing unique properties adequate for specific application, making Sn potentially the material of choice again. Sn fluoride has been also added to some dental care products as SnF₂.

The following properties of Zinc (Zn) find particular use with the present invention. Zn is a transitional metal, conductive, malleable at 100° C., no tendency for oxidation. Zn deposition can be used for Zn batteries and galvanized steel. Galvanized steel components that serve as one of the most essential fabrication components for many industrial applications. One of the most common methods for protecting steel from corrosion and achieving better outside appearance is by coating steel components with zinc (Zn), producing galvanized (or Zn coated) steel. Due to its low cost, good conductivity, light in weight, and ease for manufacturing, electronics industry widely uses galvanized steel. However, pure Zn has the tendency to also form electrically conductive Zn whiskers (FIGS. 1A-1B) during storage with similar characteristics as the Sn whiskers. Literature reports data on Sn whiskers but very little is known about Zn whiskers and the causes for their growth. Almost no data is published on this issue. In recent years many computer equipment failures (servers, routers, switches, etc.) ranging from nuisance glitches to catastrophic system failures have been attributed to Zn whiskers. A search of the web shows that the most often reported source for Zn whiskers is the bottom surface of zinc-plated raised (“access”) floor tiles commonly used in computer room construction. Other sources of zinc whiskers include zinc-plated floor supports/rails, computer equipment racks and hardware such as screws, nuts, washers and bus rails. Zinc whisker sources on the underside of floor tiles are a long distance from electronic equipment in floor racks. However, experience demonstrates that whiskers are broken free during floor-bumping activities including construction and maintenance, and become entrained in the air flow used for cooling, and then deposit into the distant electronic equipment (see FIGS. 2A-2B). As a result of all these issues with Zn it is important to explore opportunity to deposit Zn with other processes such as aerosol jet printing to be able to modify properties of Zn using pattering and process control. Therefore, Zn is also a potential candidate that can be manufactured in ink form and printed with the aerosol jet technology for production of galvanized steel with superior qualities and mitigated reliability issues.

The following properties of Magnesium (Mg) find particular use with the present invention. Mg is an alkali earth metal, is lightweight (lightest useful metal), tarnishes slightly, low melting point again great candidate for deposition with aerosol jet, reacts with water especially in powder form, highly flammable especially in thin strips and powder form but not in bulk or mass form, limited usage due to high temperature creep, corrosive, nontoxic. Since it is reactive in powder form we might need to alloy it with other metals in order to deposit it with aerosol jet but is definitely worth exploring and again good candidate to convert to ink form and explore properties when deposited with aerosol jet specifically because of its high applicability for biomedical applications.

The present invention can be used to print or deposit Mg. Mg is essential ingredient for human cells, common additive in fertilizers, stabilizes abnormal nerve excitation, source of illumination in photography, automotive frames due to lightweight, because of low weight and good mechanical and electrical properties, magnesium is widely used for manufacturing of mobile phones, laptop and tablet computers, cameras, and other electronic components. Could be used in treating patients suffering from type 2 diabetes, and hypertension since these diseases are associated with magnesium deficiency. Alloyed with zinc to produce the zinc sheet used in photoengraving plates in the printing industry, dry-cell battery walls, and roofing. When alloyed with aluminum the alloy is used in sports equipment such as golf clubs, fishing reels, and archery bows and arrows. Many car and aircraft manufacturers have made engine and body parts from magnesium especially due to its light weight.

The following properties of Lithium (Li) find particular use with the present invention. Li is a reactive metal, alkali metal; flammable, light, soft metal. Li as part of a compound can be converted into ink and deposited with the aerosol jet process examples of some compounds are: lithium cobalt dioxide (LiCO₂), lithium-nickel-manganese oxide (LNMO), and lithium-aluminum-germanium phosphate (LAGP) materials.

The present invention can be used to print or deposit Li. Lithium and its compounds have several industrial applications, including heat-resistant glass and ceramics, lithium grease lubricants, flux additives for iron, steel and aluminum.

Production, lithium batteries and lithium-ion batteries. These uses consume more than three quarters of lithium production. Lithium batteries are widely used in products such as portable consumer electronic devices. Wireless alarm systems, medical applications e.g. pacemakers, like implantable defibrillators, neurostimulators, and drug infusion systems. Also projected for use in other electronics, such as emergency locator transmitters. Other applications are watches, camcorders, digital cameras, thermometers, calculators, laptop BIOS, communication equipment and remote car locks. Cost is reduced with aerosol jet application.

The following properties of High Entropy Alloys (HEAs) find particular use with the present invention. Alloys with 5 or more principle elements with nearly equal atomic percentage. Exhibit superior and unique properties such as high strength, wear resistance, high temperature strength, high fatigue life and corrosion resistance. There are many combinations of HEA we have studied only two so far: cobalt-chromium-iron-nickel-manganese (CoCrFeNiMn) and aluminum-cobalt-chromium-iron-nickel (Al_{0.1}CoCrFeNi).

The present invention can be used to print or deposit High Entropy Alloys Applications. HEAs potential to be promising candidates for many applications but applications are yet to be determined. We have studied the two alloys with the goal for biomedical application and so far have seen that they could potentially exhibit better properties then stainless steel currently used in stent implants. The idea is that these materials can be converted to ink and printed with the aerosol and potentially use for variety of applications due to their unique combination of properties.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. An ink comprising, metal particles, an organic stabilizer, and a solvent.

2. The ink of claim 1, wherein the metal is selected from tin (Sn), zinc (Zn), magnesium (Mg), lithium (Li), bismuth (Bi), antimony (Sb), alloys, or high entropy alloys (HEAs).

3. The ink of claim 1, wherein the organic stabilizer is provided at between 0.01% to 2.0% weight to volume.

4. The ink of claim 1, wherein the organic stabilizer is provided at between 0.05% to 0.5% weight to volume.

5. The ink of claim 1, wherein organic stabilizer is selected from the group consisting of agar, agarose, alginate, carrageenan, gelatin, guar gum, gum arabic, gum ghatti, gum tragacanth, karaya gum, locust bean gum, xanthan gum, cellulose, pectin, mucin, dextran, starch, heparin, chitosan, hydroxy starch, hydroxypropyl starch, carboxymethyl starch, hydroxyethyl cellulose, hydroxypropyl cellulose, carboxymethyl cellulose, acrylic polymer, polyamide, polyimide, polyester, polyether, polymeric vinyl compounds, polyalkene, substituted derivatives thereof, copolymers, substituted derivatives, and mixtures thereof.

6. The ink of claim 1, wherein the solvent is water.

7. The ink of claim 1, wherein the organic stabilizer is a thixotropic agent.

8. The ink of claim 1, wherein the metal is defined further as metal particles having a size range from 5 to 250 nm, from 10 to 250 nm, from 50 to 150 nm, or an average size of 100, 125, 150, or 175 nm.

9. The ink of claim 1, further comprising at least one of a preservative, a flux, or a color.

10. A method of using a metal ink comprising:
mixing a stabilized ink comprising metal particles, an organic stabilizer, and a solvent, wherein the ink is loaded into an ink cartridge;
preparing a surface of a substrate in need of coating with a metal; and
spraying the stabilized ink from the cartridge using a printer, onto the substrate to increase at least one or appearance, solderability, or electric conductivity of the surface of the substrate.

11. The method of claim 10, wherein the metal is selected from tin (Sn), zinc (Zn), magnesium (Mg), lithium (Li), bismuth (Bi), antimony (Sb), alloys, or high entropy alloys (HEAs).

12. The method of claim 10, wherein the organic stabilizer is provided at between 0.01% to 2.0% weight to volume.

13. The method of claim 10, wherein the organic stabilizer is provided at between 0.05% to 0.5% weight to volume.

14. The method of claim 10, wherein the organic stabilizer is selected from the group consisting of agar, agarose, alginate, carrageenan, gelatin, guar gum, gum arabic, gum ghatti, gum tragacanth, karaya gum, locust bean gum, xanthan gum, cellulose, pectin, mucin, dextran, starch, heparin, chitosan, hydroxy starch, hydroxypropyl starch, carboxymethyl starch, hydroxyethyl cellulose, hydroxypropyl cellulose, carboxymethyl cellulose, acrylic polymer, polyamide, polyimide, polyester, polyether, polymeric vinyl compounds, polyalkene, substituted derivatives thereof, copolymers, substituted derivatives, and mixtures thereof.

15. The method of claim 10, wherein the solvent is water.

16. The method of claim 10, wherein the organic stabilizer is a thixotropic agent.

17. The method of claim 10, further comprising at least one of a preservative, a flux, or a color.

18. The method of claim 10, wherein the metal is defined further as metal particles having a size range from 5 to 250 nm, from 10 to 250 nm, from 50 to 150 nm, or an average size of 100, 125, 150, or 175 nm.

19. A method of making an electronic device comprising:
obtaining a stabilized ink comprising metal particles, an organic stabilizer, and a solvent, wherein the ink is loaded into an ink cartridge;
preparing a surface comprising one or more electronic components in need of coating with a metal; and
printing the stabilized ink from the cartridge using a printer onto the electronic component to increase at least one or appearance, solderability, or electric conductivity of the electronic component.

20. The method of claim 19, wherein the metal is selected from tin (Sn), zinc (Zn), magnesium (Mg), lithium (Li), bismuth (Bi), antimony (Sb), alloys, or high entropy alloys (HEAs).

21. The method of claim 19, wherein the organic stabilizer is provided at between 0.01% to 2.0% weight to volume.

22. The method of claim 19, wherein the organic stabilizer is provided at between 0.05% to 0.5% weight to volume.

23. The method of claim 19, wherein the organic stabilizer is selected from the group consisting of agar, agarose, alginate, carrageenan, gelatin, guar gum, gum arabic, gum ghatti, gum tragacanth, karaya gum, locust bean gum, xanthan gum, cellulose, pectin, mucin, dextran, starch, heparin, chitosan, hydroxy starch, hydroxypropyl starch, carboxymethyl starch, hydroxyethyl cellulose, hydroxypropyl cellulose, carboxymethyl cellulose, acrylic polymer, polyamide, polyimide, polyester, polyether, polymeric vinyl compounds, polyalkene, substituted derivatives thereof, copolymers, substituted derivatives, and mixtures thereof.

24. The method of claim 19, wherein the solvent is water.

25. The method of claim 19, wherein the organic stabilizer is a thixotropic agent.

26. The method of claim 19, further comprising at least one of a preservative, a flux, or a color.

27. The method of claim 19, wherein the metal is defined further as metal particles having a size range from 5 to 250 nm, from 10 to 250 nm, from 50 to 150 nm, or an average size of 100, 125, 150, or 175 nm.
